(19) United States
(12) Patent Application Publication
(10) Pub. No.: US 2009/0328101 A1
(43) Pub. Date: Dec. 31, 2009

(54) USER INTERFACE FOR MOBILE TV INTERACTIVE SERVICES

(75) Inventors: Teemu Suomela, Oulu (FI); Henri T. Hamalainen, Espoo (FI); Hanna Sillanpaa, Helsinki (FI); Sara Belt, Oulu (FI); Arto Kiiskinen, Lapinkyla (FI); Petri T. Laine, Oulu (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/164,798

(22) Filed: Jun. 30, 2008

(51) Int. Cl. H04N 5/445; G06F 3/041

(52) U.S. Cl. 725/40; 345/173; 725/43

(57) ABSTRACT

A method includes providing an electronic program guide that presents content programming information for one or more program channels on a broadcast TV device; detecting a selection of a program block in the electronic program guide, the selected program block corresponding to a program scheduled on a program channel; and providing a program indicator block corresponding to the selected program block, the program indicator presenting detailed programming information related to the scheduled program including any program reminder or program recording state setting.

### BACKGROUND

1. Field

The aspects of the disclosed embodiments generally relate to graphical user interfaces, and in particular, to graphical user interfaces in mobile TV technology.

2. Brief Description of Related Developments

Interactive services are part of the Open Mobile Alliance Mobile Broadcast Services Enabler Suite (OMA BCAST) service guide. The OMA BCAST is an open global specification for mobile TV and on-demand video services which can be adapted to any IP-based mobile and Peer to Peer (P2P) content delivery technology. The OMA BCAST specification is designed to support broadcast technologies such as Digital Video Broadcasting (DVB-H), 3^{rd} Generation Partnership Project (3GPP), Multimedia Broadcast Multicast Service (MBMS),), 3^{rd} Generation Partnership Project 2 (3GPP2) and mobile unicast streaming systems. The OMA BCAST standard specifies a variety of features including electronic service guide, file and stream delivery, service and content protection, terminal and service provisioning, interactivity and notifications.

In DVB-H Mobile TV systems, interactive services are delivered in the OMA BCAST service guide via Interactivity Data elements and related Interactivity Media Documents. An Interactivity Media Document may specify multiple different types of services. Actions for interactive services can include, for example, launching an application, starting a web page, sending a Short Message Service (SMS) and voting, or some combination of these actions. The Interactivity Media Document structures can also specify choice elements and allow for building voting systems.

Multiple interactive services can also be associated with a channel or program. An interactive service will generally have a time span during which it is valid and active. The user should be able to detect and access interactive services when consuming a TV channel or program (also referred to herein as “broadcast content”). Multimedia Broadcast Multicast Service based mobile TV systems also use the BCAST program guide and allow the same Interactivity mechanism.

Interactive services browsing requires a user interface. Services are meant to be accessed while consuming broadcast content. It would be advantageous to be able to build a user interface that supports all required options and promotes interactive services when they are active.

With mobile TV broadcasts, different kinds of interactive services can be provided with each program. These services are essential to the service providers and operators in order to provide other valuable services and generate more income and revenue. One example of an interactive service that can be offered is the ability to send a short message service message, such as a vote for a competitor on a program. For example, many of the “competition” style TV programs allow viewers to call in to cast a “vote” for a particular competitor. Making these types of interactive services as visible as possible, and easy to access, is a key element in providing the interactive services. The users need to be aware of the interactive services features and must be able to easily understand and access the underlying functionality. In the past, formally accessing these types of services has not been straightforward, and has typically required that the user access an options menu of the device. The interactive services in this type of menu are not necessarily visible enough among other items, and accessing these services can be difficult. It would be advantageous to be able to easily and quickly recognize, identify and access interactive services in a device without the need to open and parse a separate menu.

An essential part of the TV and broadcast content experience is an electronic program guide that gives the user more information about programming and the content of a broadcast. The electronic program guide can be used to provide the user with, among other things, detailed information about the times and content of ongoing and future broadcasts and programs.

Typically, an electronic program guide will display a list of all of the available channels. The list of channels can include the channel logo or identifier and program information (e.g. program name and time) and it would be helpful to be able to switch to any desired channel in a quick and convenient fashion. One example of such an electronic program guide is shown in FIG. D1. Enabling fast channel selection from the electronic program guide can be a problem. It would be advantageous to be able to easily switch from the electronic program guide to a channel or a program without the need to execute multiple steps.

Generally, the user can view the ongoing and future TV programs from electronic program guide view. However, with small display devices, the display or viewing area for the program guide can be limited. Thus, some of the program information may not be fully visible, if visible at all. One aspect of the programming guide is the ability to set a reminder for a program or to set up to record to the program. In a device with a small or limited display area, such as a handheld terminal, the reminder or programming options may not be visible. It would be advantageous to make reminder and programming information and fields readily visible to the user no matter how larger or small the display area of the particular device is.

Part of TV experience is the program recording feature. The program recording feature allows user to record a program, such as a TV show, for later viewing. Generally a user can set several recordings that are not overlapping. However, the user may not be able to check the set recordings from any user interface of the application. It would be advantageous to have a view that allows the user to easily to view, manage and edit the set recordings.

Changing a channel is an essential feature of any TV device. With small portable devices the full screen picture size is important in order to obtain as much viewable area as possible. When the device is in the full-screen mode it is not always possible to easily discern how to change the channel. In many cases, the channel changing functions are not visible to the user and one must hit the “escape” key to revert to the normal screen size where the corresponding control functions are displayed and available. In situations where the channel changing functions are displayed in the full-screen mode, they are generally represented by soft key controls that overlay an area of the picture. Touch screen devices may not provide any hardware keys that easily enable a channel change. It would be advantageous to have a simple and fast way to change a channel on a mobile TV device even when the device is in the full-screen mode.

Small display terminals tend to switch off illumination of the screen and disable all streaming functionalities when a key pad lock function is activated in the terminal. The purpose for this is generally to prevent inadvertent usage of the TV and video area applications, among other applications, and prevent battery drain. It would be advantageous to be able to watch a TV broadcast on TV application devices even while the terminal keys are locked or in a safe mode when a keypad lock function.

The user interface for mobile TV technology can have several different states that constantly change without the need for any user interaction. In different states, the user can execute different interactions that are important for the current state of the user interface. The changes in functionality that correspond to a specific state are handled in different ways in different devices. In some cases there are fixed hardware keys and option menu items that are configured to execute the functionality corresponding to the specific state of the user interface. Hardware keys are generally not a preferred solution because there are a limited number of such keys on a device and an options menu is not a convenient solution for long-term usage. It would be advantageous to be able to change functionality of the middle soft key of the device on which the mobile TV application, and its label, in reaction to changes in content. It would also be advantageous to have the label of the soft key and the corresponding function represented by the middle soft key change to correspond to the state that is currently active on the application.

A mobile TV application can be opened so that a user selects a channel that is desired to be watched. The channel selection must be as smooth as possible to ensure flawless interaction between the user and the mobile TV application. Because the loading of a TV channel in handheld terminals can take a period of time, depending on the technology being used, presenting the currently running content of a channel can be important to the ease of use of the device and the application. Presently, the content of a mobile TV channel is not visible to the user before the channel is selected and opened. If the content of the channel is not visible before selection of the channel, opening the mobile TV application and finding a desired program can take an undesireable amount of time. This can make the application cumbersome for the user. It would be advantageous to provide a user friendly way to allow a user to open a mobile TV application, preview and select a desired channel.

Mobile TV broadcasts can include several types of channels configured by the service provider. Some can be considered “free” channels, while others are “pay” channels. The “pay” channels require a purchase payment prior to the content or program being available to be viewed. The user interaction to execute the channel/program purchase process is essential to the purchase process. With a smooth interaction process, the user can easily make the purchase and more channels and programs might be made available in this fashion. With a poor or cumbersome interaction process, the whole interaction is endangered, since a user will not be inclined to attempt the purchase. Many systems require contacting a live operator or multiple user interaction steps in order to purchase a program on a channel.

For example, in some applications, the content of a TV channel, which is not purchased, will display a blank screen with text guidance to access an options menu where user can execute the steps to purchase the channel. The purchase must always be executed from the options menu and the item may not easily be found because menu structures can be complicated in wide application areas. It would be advantagous to provide a simplified and easy way for a user of a mobile TV application device to select and purchase a “pay” channel program.

### SUMMARY

The aspects of the disclosed embodiments are directed to at least a method, apparatus, user interface and computer program product. The aspects of the disclosed embodiments include providing an electronic program guide that presents content programming information for one or more program channels on a broadcast TV device; detecting a selection of a program block in the electronic program guide, the selected program block corresponding to a program scheduled on a program channel; and providing a program indicator block corresponding to the selected program block, the program indicator presenting detailed programming information related to the scheduled program including any program reminder or program recording state setting.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2 illustrates an exemplary device application on which aspects of the disclosed embodiments can be practiced;

FIG. 3 illustrates a block diagram of the architecture of an exemplary user interface incorporating aspects of the disclosed embodiments;

FIG. 4A1 is an exemplary screen shot of aspects of the disclosed embodiments;

FIGS. 4B1-4B6 illustrate exemplary screen shots of aspects of the disclosed embodiments;

FIG. 4C is a flowchart illustrating an aspect of the disclosed embodiments;

FIGS. 4D1-4D5 illustrate exemplary screen shots of aspects of the disclosed embodiments;

FIG. 4E illustrates an exemplary screen shot of aspects of the disclosed embodiments;

FIG. 4F illustrates an exemplary screen shot of aspects of the disclosed embodiments;

FIG. 4G illustrates an exemplary screen shot of aspects of the disclosed embodiments;

FIG. 4H illustrates an exemplary screen shot of aspects of the disclosed embodiments;

FIGS. 4I1-I6 illustrate exemplary screen shots of aspects of the disclosed embodiments;

FIGS. 5A-5B illustrate exemplary screen shots of an aspect of the disclosed embodiments;

FIGS. 6A and 6B are illustrations of exemplary devices that can be used to practice aspects of the disclosed embodiments;

FIG. 7 illustrates a block diagram of an exemplary system incorporating features that may be used to practice aspects of the disclosed embodiments; and

FIG. 8 is a block diagram illustrating the general architecture of an exemplary system in which devices used to practice aspects of the disclosed embodiments may be used.

### DETAILED DESCRIPTION OF THE EMBODIMENT(S)

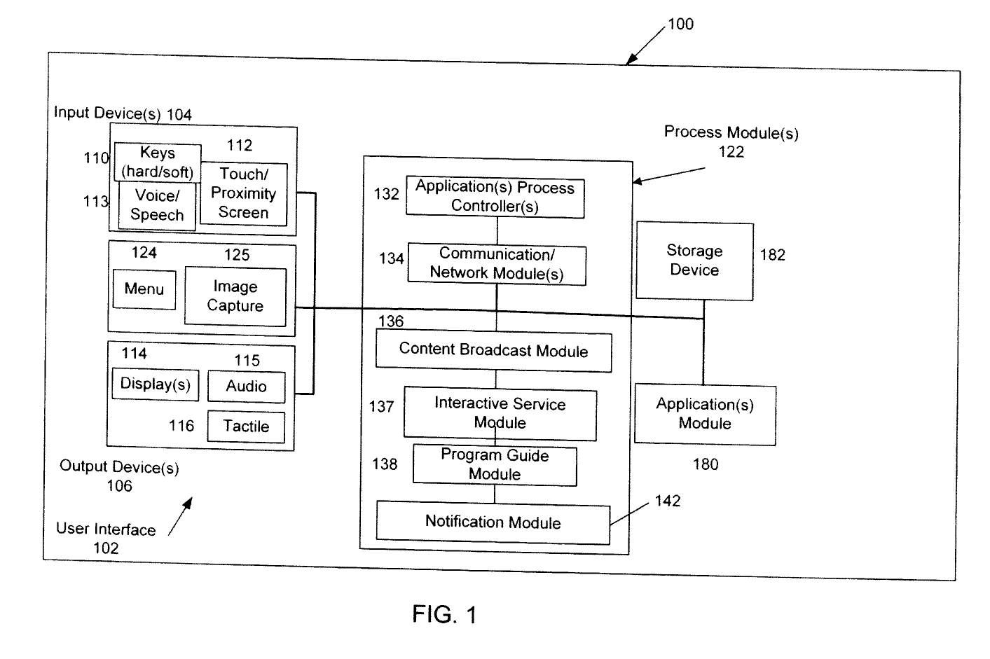

FIG. 1 illustrates one embodiment of a system 100 in which aspects of the disclosed embodiments can be applied. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments generally allow a user to interface with broadcast content programs that access and utilize interactive services, such as mobile TV applications. Referring to FIG. 1, the system 100 of the disclosed embodiments can generally include input device(s) 104, output device(s) 106, process module(s) 122, applications module(s) 180, and storage/memory device(s) 182. The components described herein are merely exemplary and are not intended to encompass all components that can be included in the system 100. The system 100 can also include one or more processors or computer program products to execute the processes, methods, sequences, algorithms and instructions described herein.

The input device(s) 104 are generally configured to allow a user to input data, instructions and commands to the system 100. In one embodiment, the input device 104 can be configured to receive input commands remotely or from another device that is not local to the system 100. The input device 104 can include devices such as, for example, keys 110, touch screen 112, menu 124, imaging device 125, such as a camera or such other image capturing system. In alternate embodiments the input device can comprise any suitable device(s) or means that allows or provides for the input and capture of data, information and/or instructions to a device, as described herein. The output device(s) 106 are configured to allow information and data to be presented via the user interface 102 of the system 100 and can include one or more devices such as, for example, a display 114 (which can be part of or include touch screen 112), audio device 115 or tactile output device 116. In one embodiment, the output device 106 can be configured to transmit output information to another device, which can be remote from the system 100. While the input device 104 and output device 106 are shown as separate devices, in one embodiment, the input device 104 and output device 106 can be combined into a single device, and be part of and form, the user interface 102. The user interface 102 of the disclosed embodiments can be used to control a mobile broadcast content application, such as a mobile TV application. While certain devices and modules are shown and described with respect to FIG. 1, the scope of the disclosed embodiments is not limited by any one or more of these devices, and an exemplary embodiment can include, or exclude, one or more devices.

The process module 122 is generally configured to execute the processes and methods of the disclosed embodiments. The application process controller 132 can be configured to interface with the applications module 180, for example, and execute application processes with respects to the other modules of the system 100. In one embodiment the applications module 180 is configured to interface with applications that are stored either locally to, or remote from, the system 100 and/or web-based applications. The applications module 180 can include any one of a variety of applications that may be installed, configured or accessible by the system 100, such as for example, office, business, media players and multimedia applications, web browsers and maps. In alternate embodiments, the applications module 180 can include any suitable application. The communication module 134 shown in FIG. 1 is generally configured to allow the device to receive and send communications and messages, such as text messages, chat messages, multimedia messages, video and email, for example. The communication module 134 is also configured to receive information, data and communications from other devices and systems.

The process module 122 can include a broadcast content application module or engine 136. In one embodiment, the broadcast content application module comprises a mobile TV application. In alternate embodiments, the broadcast content module comprises any suitable application for providing or distributing content rich programming, other than including mobile TV applications. For example, content applications can comprise video-on-demand services, which are not broadcast.

The process module 122 can also include an interactive services module 138 that is configured to interface with the broadcast content application and service providers to provide the interactive services features described herein.

The process module 122 can also include an electronic program module 138 that is configured to received content programming information from the respective content service provider(s) and interface with the broadcast content module 136 and interactive services module 137

In one embodiment, the process module 122 can also include a notification module 142 that is configured to provide interactive service notifications as interactive services become available on broadcast contents.

Referring to FIG. 1, in one embodiment, the user interface of the disclosed embodiments can be implemented on or in a device that includes a touch screen display 112, proximity screen device or other graphical user interface. In one embodiment, the display 112 can be integral to the system 100. In alternate embodiments the display may be a peripheral display connected or coupled to the system 100. A pointing device, such as for example, a stylus, pen or simply the user's finger may be used with the display 112. In alternate embodiments any suitable pointing device may be used. In other embodiments, the display may be any suitable display, such as for example a flat display that is typically made of a liquid crystal display (LCD) with optional back lighting, such as a thin film transistor (IFT) matrix capable of displaying color images. Although display 114 of FIG. 1 is shown as being associated with output device 106, in one embodiment, the displays 112 and 114 form a single display unit.

The terms “select” and “touch” are generally described herein with respect to a touch screen display device. However, in alternate embodiments, the terms are intended to encompass the required user action with respect to other input devices, and do not necessarily require physical contact for an action to be carried out or executed. For example, with respect to a proximity screen device, it is not necessary for the user to make direct contact in order to select an object or other information, such as a menu item or icon, on the screen of the device. Thus, the above noted terms are intended to include that a user only needs to be within the proximity of the device to carry out the desired function. It should also be understood that arrow keys on a keyboard, mouse style devices and other cursors can be used as a pointing device and to move a pointer.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity displays or screens, where navigation on the display and menus of the various applications is performed through, for example, keys 110 of the system or through voice commands via voice recognition features of the system.

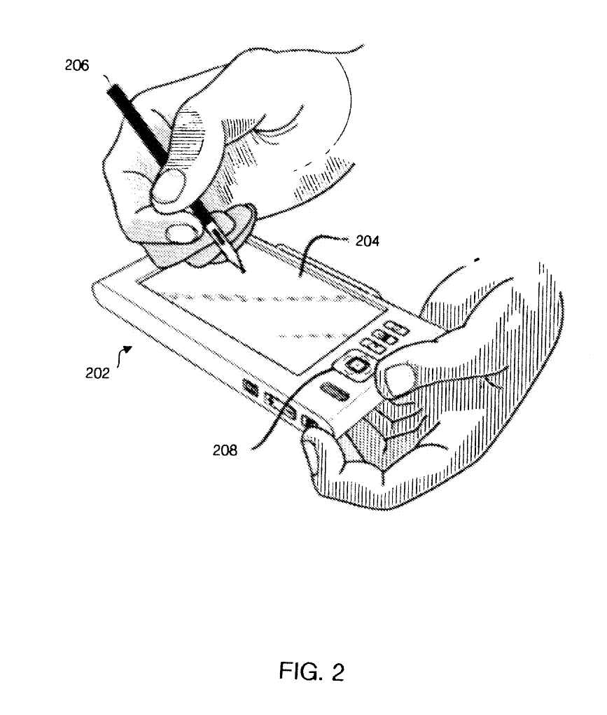

FIG. 2 illustrates one example of a device 202 that includes a touch screen display 204 on which aspects of the disclosed embodiments can be executed. A pointing device 206 can be used to provide input signals to the device 202, such as the selection of functions and menu items. Although the example in FIG. 2 shows a stylus type device being used as the pointing device 206, it will be understood that any suitable device that is compatible with a touch screen display, such as for example the user's finger, can be used. In alternate embodiments, such as where the device does not include a touch screen display, any suitable pointing device or cursor control device can be used including for example, a mouse style cursor, trackball, arrow keys of a keyboard, touchpad control device or joystick control. For example, the control 208 in FIG. 2, which in one embodiment comprises a cursor control device, could be used to position the cursor or pointing device. In an exemplary embodiment, the user's finger can function as the pointing device 206. The user can contact or point to a position on the screen to provide an input, such as selecting a notification or interactive services indicator.

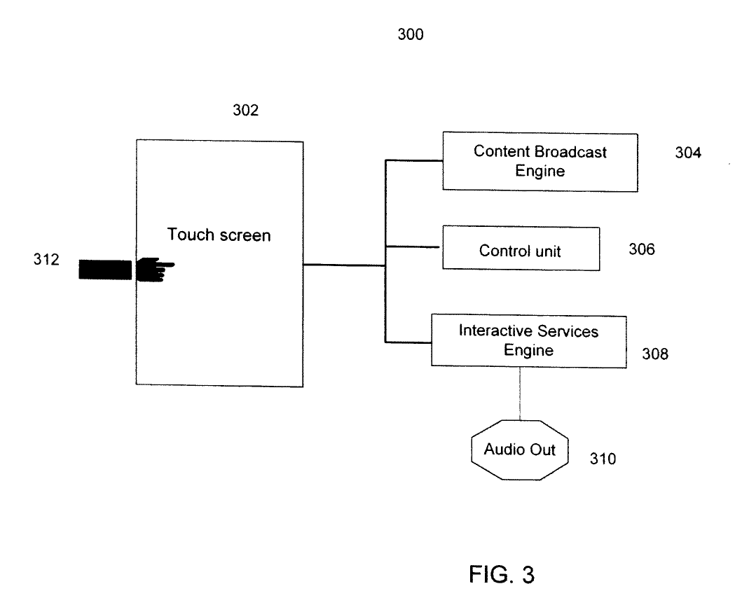

FIG. 3 illustrates an embodiment of an exemplary broadcast content user interface system. In one embodiment, the user interface system 300 includes a display interface device 302, such as a touch screen display. In alternate embodiments, the display interface device 302 comprises a user interface for a visually impaired user that does not necessarily present text or indicators on the display so that they can be viewed, but rather allows the user to provide inputs, such as voice commands, and receive feedback in the form of text-to-speech conversion, for the selection of the functions and commands in accordance with the embodiments described herein. For example, when an interactive services notification is generated, a text-to-speech application can inform the user of the notification as well as its content. Further, text corresponding to each of the selectable menu items can be processed with a text-to-speech processing application to identify each of the selectable menu items. One example of a text-to-speech conversion application is described in U.S. patent application Ser. No. ______, filed on Jun. ______, 2008, the disclosure of which is incorporated herein by reference in its entirety. Docket No. 684-013415-USPAR, NC63779.

As shown in FIG. 3, a pointing device or pointer 312, which in one embodiment can comprise a stylus or the user's finger, is used to provide input to the display interface device 302. A broadcast content engine 304 is used to provide the content and interactive services described herein. A control unit 306 is used to provide the programs and content to the display interface device for presentation or display. The interactive services engine 308 can access and provide interactive services described herein. An audio output device 310, such as for example a loudspeaker or headset device, can be used to output audio data. In one embodiment, the audio output device 310 can be located remotely from the other user interface 300 elements. For example, a wireless connection can be used to couple the audio output device 310 to the other elements of the system 300 for suitable output of the audio of the programs and interactive services.

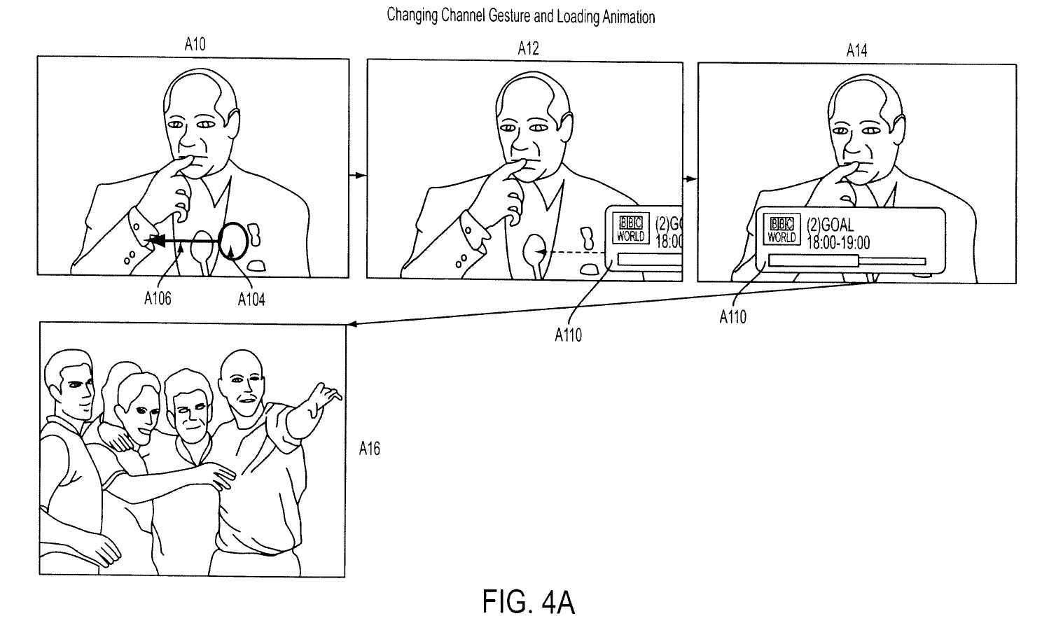

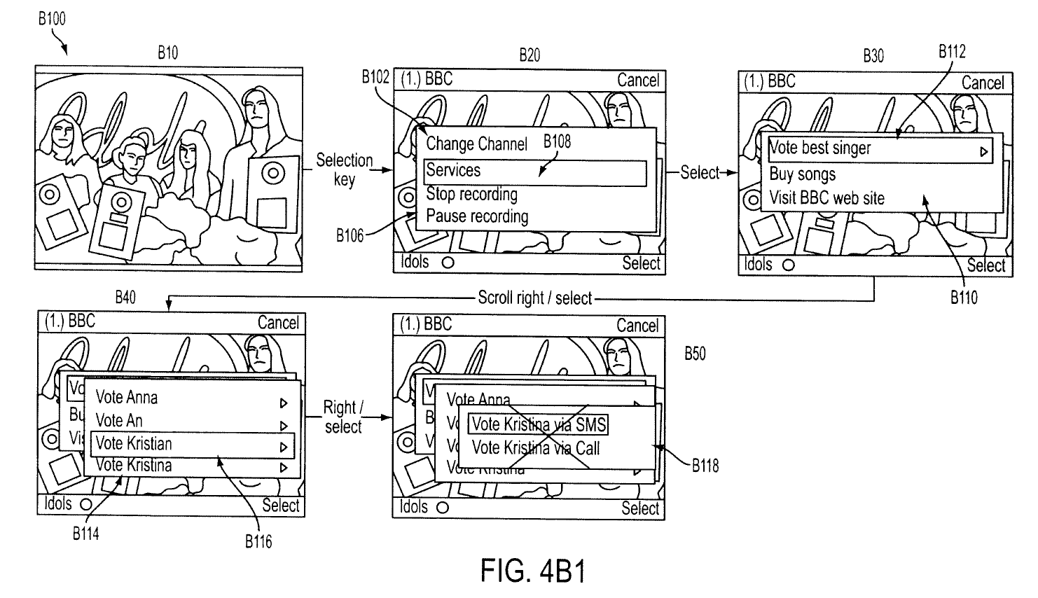

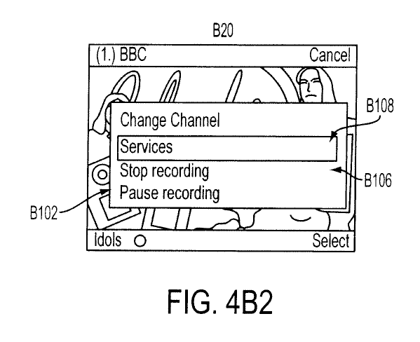

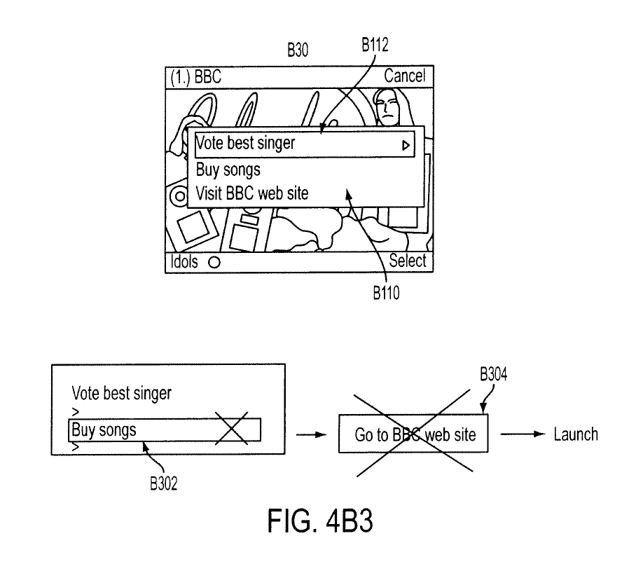

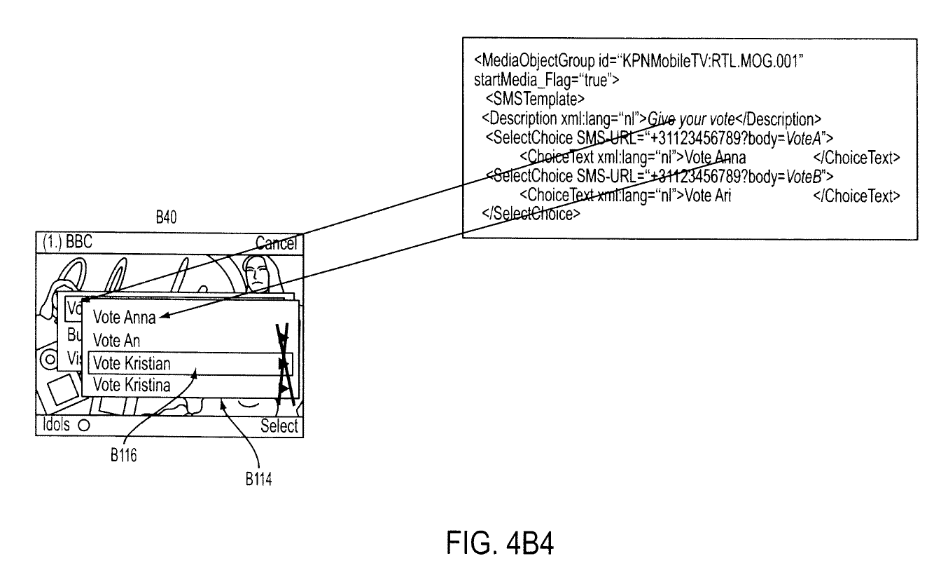

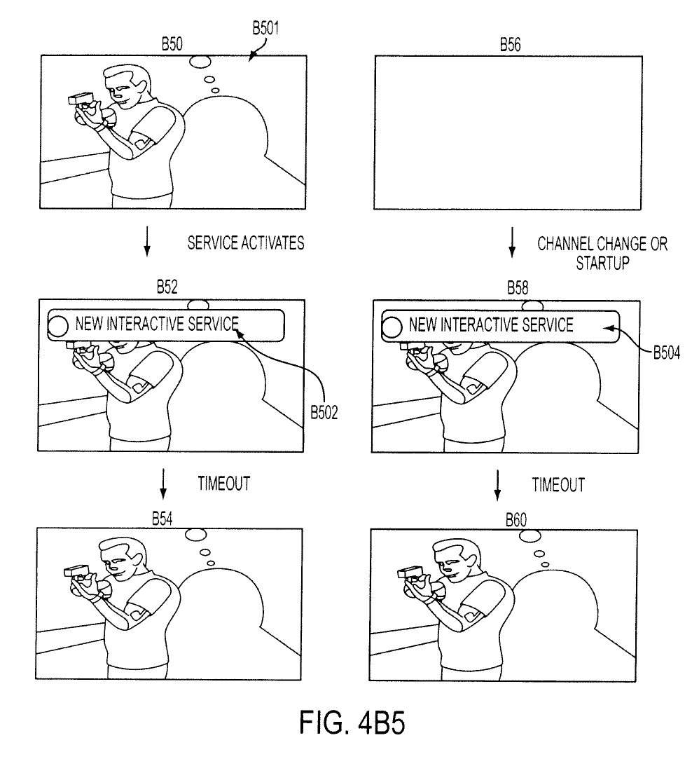

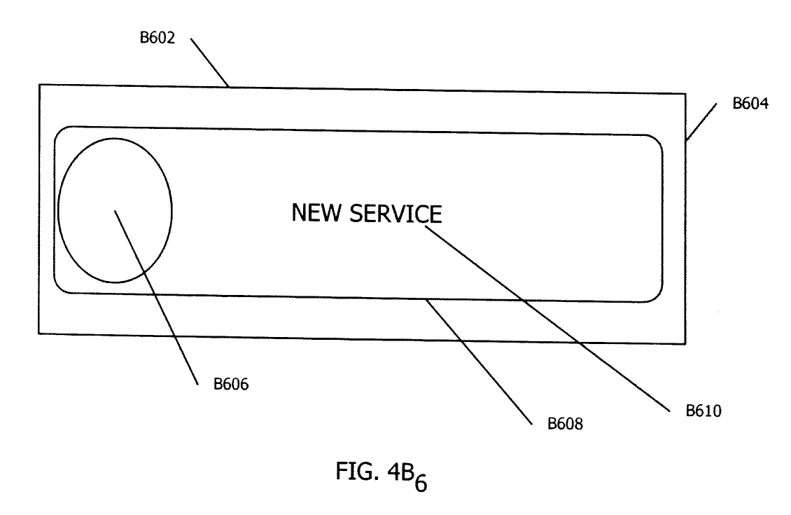

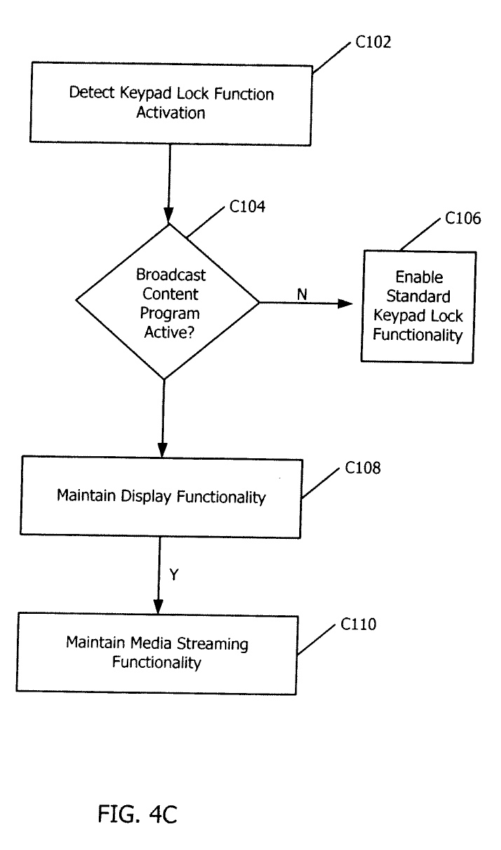

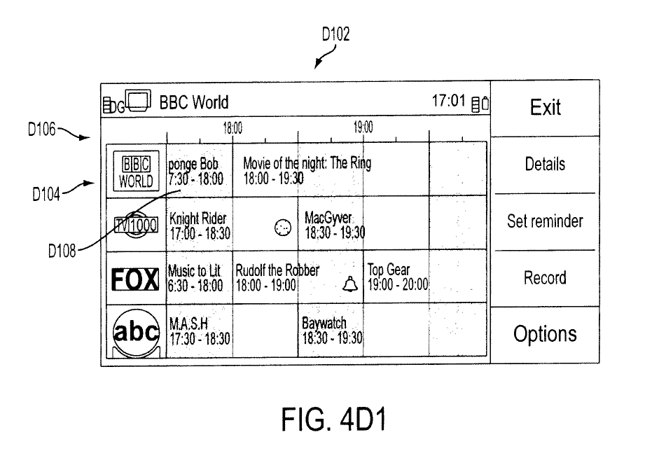

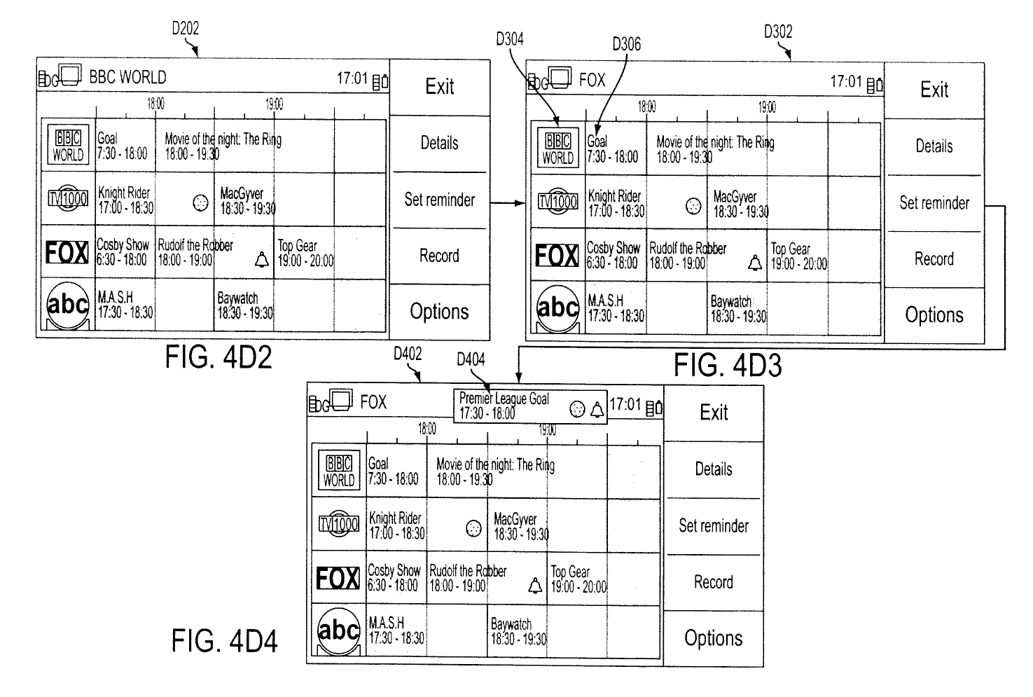

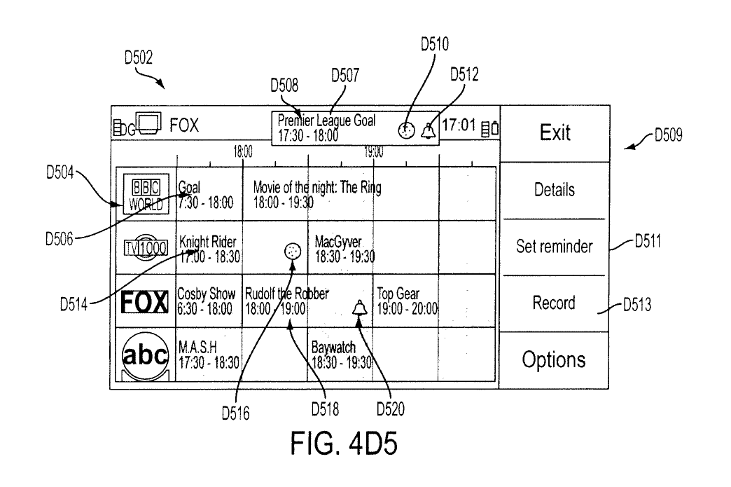

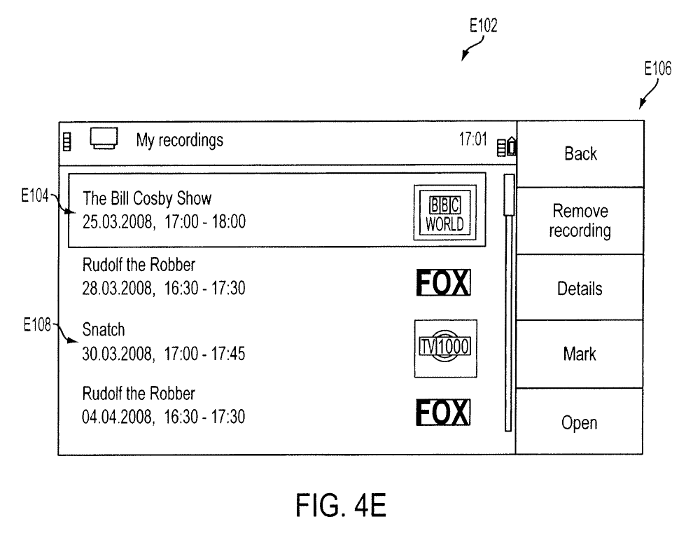

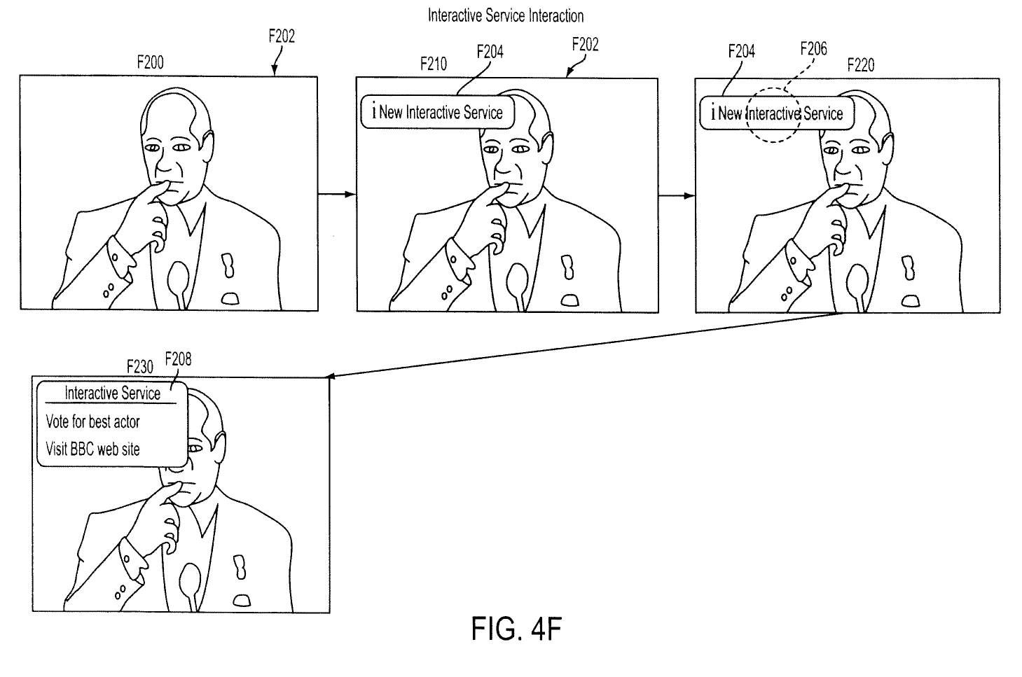

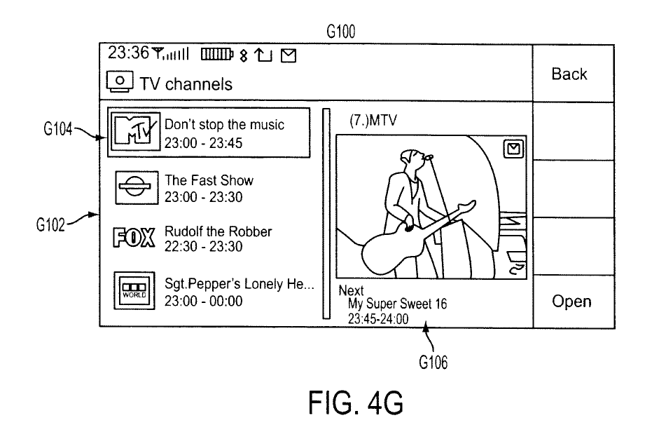

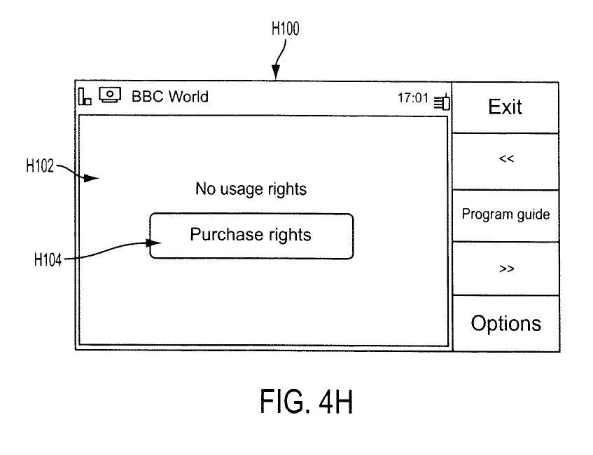

Referring to FIG. 4B, one example of presenting interactive services in a hierarchical tree menu in a user interface incorporating aspects of the disclosed embodiments is illustrated. Screenshot B10 illustrates the program or broadcast content B100 currently being presented or shown. The terms “program” and “broadcast content” as used herein are not limited to broadcast TV. The aspects of the disclosed embodiments can also be applied to, and are intended to encompass, unicast bearers, such as the third generation of developments in wireless technology (3G) and wireless local area networks (WLAN), for example. In one embodiment, the programs can be related to video-on-demand services, or other non-broadcast services.

In screenshot B20, a context menu B102 is displayed that provides access functions, controls and services related to the program or broadcast content being presented. This can be called the first level, context sensitive menu. The menu B102 can be called by activating a designated function key of the device or some other suitable control or feature activation mechanism. In alternate embodiments, any suitable mechanism to generate the menu B102 can be used, including an automatic notification when an interactive service is made available. In one embodiment, where the device on which the broadcast content application is running includes a touch screen display, contacting the display will automatically launch or open the menu B102. As shown in screen B20, menu B102 provides selection items and/or controls, also referred to as “tabs”, to change channels, stop a recording or pause a recording. In alternate embodiments, any suitable controls or control functions can be provided in the menu B102.

The menu B102 also includes a “services” tab B108. The services tab B108 will allow the user to access, control and execute actions related to available interactive services. The context menu B102 displays services only if there are interactive services currently active. Although the menu B102 includes a tab B108 that allows the user to access a “services” menu, in alternate embodiments the available interactive services can be presented as tabs directly in the menu B102. In one embodiment, interactive services are monitored actively, and a service is removed from the menu B102 if a service validity period is exceeded. The term “validity period” as used herein generally means that when a service is no longer available, the service is automatically removed from the corresponding menu.

In this example, the broadcast content B100 that is being presented is associated with interactive services. The interactive services are meant to be accessed while consuming the broadcast content B100, as is described herein. In one embodiment, as shown in screenshot B20, the context menu B102 opens on top of the running broadcast content or program B100. It is a feature of the disclosed embodiments that the menu B102 is presented on top of the running broadcast content. If there are not many interactive services or control functions in the menu B102, a larger area of the broadcast content B100 remains visible. The user can continue to view the running broadcast content B100 while parsing or navigating through the available controls and/or services. For example, the user can select a service, launch a service or return to the broadcast content while continuing to view the broadcast content.

The user can browse the menu B102 to deeper levels, or sub-levels to access and see details about interactive services, access choices and eventually execute a related action. An action can include, for example, sending a text message, opening a messaging editor, starting a phone call, or opening an application. In alternate embodiments, an action can include any suitable function that might be associated with broadcast content and interactive services. The context menu B102, in screenshot B20, displays the interactive services B106 in a hierarchical tree style menu. In alternate embodiments, the menu B102 can be presented in any suitable or desired format. The items in the menu B102 are interactive services related to the broadcast content being watched, and are currently active. The menu B102 is created dynamically from interactivity data elements and interactivity media documents that are received from the BCAST program guide. A service is determined to be active if there are one or more active channel/program interactivity data elements. Upon detecting that a channel/program interactivity data element is active, the corresponding menu item can be activated.

As shown in screen B20 of FIG. 4B1, the user selects the “Services” menu item B108. Selection of the services menu item B108 can be done in any suitable manner, including for example, using a function key of the device, cursor activation or contacting the display. The selection of the “Services” menu item B108 in screen B20 leads to the sub-menu or sub-level B110 shown in screenshot B30. In one embodiment, this level can be described as the interactive services level. As shown in FIG. B3, information related to active Interactivity Data items are shown at this interactive service level. The sub-level B110 is dynamically created and will only be presented if there are interactive service choices available. The visible text in each menu item B112 being displayed can be taken from the Interactivity Media Document::Description or InteractivityMedia::InteractivityType field.

The submenus for interactive services, such as submenu B110 shown in FIG. 4B3, are created only if the selected Interactivity Data element has Interactivity Media Document choices. If there are no choices available, the items in menu B110 at this level lead directly to action launchers. An action launcher is generally a menu selection item that, when selected or activated, directly leads to the execution of an action. For example, referring to FIG. 4B3, selection of the menu item “Buy songs” B302 leads directly to the launching of the browser to open the related web site. The level related to “Go to BBC web site” B304 is skipped as unnecessary data, since there are no interactive services choices available at that level. Thus, selection of “buy song” B302 takes the user directly to the website where the songs can be purchased.

Referring to FIG. 4B1, the user can browse the menu or tree B110 of screen B30 further by selecting one of the menu elements displayed in the menu B110. In the example shown in screen B30, the menu item for “Vote best singer” B112 is selected. The selection of this menu item B112 leads to the screen shown in screenshot B40. As shown in FIG. 4B4, screenshot B40 presents an interactive services choice menu B114 with a list of persons that can be voted for. The visible choices are created from the related Interactivity Media Document and SMST Template. Selection of one of the choices, a person on the list, directly and/or immediately executes the related action of a “vote” for the person. Thus, selection of “Vote Kristian” menu item B116 will result in the execution of the corresponding action, which in this case is to send an SMS message to “vote” for Kristian. In alternate embodiments, any suitable method for casting a vote can be used. Since the menu item B116 is an “action” item, there is no need to include a further sub menu level B118 shown in screen B50. In one embodiment, as shown in FIG. 4B4, the text for each menu item B114 can be taken from the Choice Text field.

In one embodiment, after an action has been executed, a “wait” dialog can be displayed. For example, referring to FIG. 4B4, when the action “Vote Kristian” B116 is selected, an SMS message corresponding to the desired action is sent. While the SMS message is being sent, the wait dialog can be displayed on the display of the device. The wait dialog can generally comprises an animation that informs the user that the system is busy or “working”. In one embodiment a progress bar can be displayed that indicates when the system will complete the current task or action.

In one embodiment, prior to executing an action, a confirmation note can be presented to the user to confirm the desired action. Referring again to the example with respect to FIG. 4B4, prior to sending the SMS, a confirmation note, such as “About to send interactive SMS. Proceed?” can be presented to the user. The user can then have the option to confirm or reject the action prior to its execution. In one embodiment, the message body and target number do not need to be presented to the user.

The aspects of the disclosed embodiments can also provide an automatic notification to a user when new interactive services are available in relation to a broadcast content. For example, referring to FIG. 4B5, one embodiment of a user interface with a new interactive service notification B502 is shown. If the user is watching a broadcast content, such as the program B501 shown in screen B50, the user does not have to manually access a menu to determine if interactive services are available. Rather, while watching the program B501, if an interactive service is activated, the notification B502 is generated as shown in screen B52. Once the notification B502 is presented, the user is made aware of the availability of interactive services and can access the menu B102 of screen B21 when desired.

In one embodiment, the new interactive services indicator B502 can be presented for a pre-determined period of time. After the expiration of this time period, also referred to herein as a “timeout”, the new interactive services indicator B502 disappears or is removed from the display, as is shown in screenshot B54. In alternate embodiments, the new services indicator can be presented for any suitable time period or duration.

Similarly, if the user tunes or changes to a channel that has interactive services, a new interactive services indicator can automatically be provided to advise the user of the availability of interactive services. For example, screenshot B56 represents a channel change or broadcast content start-up. As shown in screenshot B58, the new interactive services indicator B504 is presented on top of the broadcast content. The new interactive services indicator B504 is presented or displayed for the timeout period, as shown in screenshot B60.

One example of new interactive services indicator is shown in more detail in FIG. 4B6. As shown in FIG. 4B6, the new interactive services indicator B602 can include a window B604 for the indicator, an icon B606, a middle background section B608 and a text section B610. In alternate embodiments, any suitable indicator, or combination of elements thereof, can be used to advise a user of the availability of new interactive services with respect to broadcast content. For example, a settings menu of the device can provide for user selection of the particular indicator, as well as provide settings that allow the user to change the visibility time period or duration of the indicator, position and appearance of the indicator or even toggle the new service indicator feature on/off. Although a visible new interactive services indicator is described herein, in one embodiment, the new interactive services indicator can be an audible indication, such as a text-to-speech conversion. In alternate embodiments, the new interactive services indicator can be accompanied by an audible indication or comprise some combination of visual and audio effects.

In one embodiment it is determined whether interactive services are currently active in a broadcast content program running on a device. A context menu presenting selectable menu items for each active interactive service is activated, and the context menu is displayed over a presentation of the broadcast content program. The context menu can be displayed concurrently with the presentation of the broadcast content program. A sub-menu selection item can be provided upon selection of a menu item for an interactive service, when further choice elements related to the selected menu item are available, the sub-menu selection item corresponding to a choice element related to the interactive service; and an action related to the selected menu item can be executed when no further choice elements are available. In one embodiment a confirmation note can be provided prior to executing the action.

In one embodiment, determining if interactive services are currently active in the broadcast content program can include determining if there are one or more channel/program interactivity data elements active; and activating at least one menu item corresponding to the one or more active channel/program interactivity data elements. Only active interactive services related to the channel and program being watched can be presented and a service validity period can be monitored for each interactive service. A service can be removed from the menu if the service validity period is exceeded.

A new interactive service indicator can be provided over the broadcast content program after determining that at least one interactive service is available and prior to activating the context menu. In one embodiment, the new interactive service indicator can be selected to activate the context menu.

In one embodiment, the method can also include detecting a selection of a menu item; determining if at least one other choice element related to the selected menu item is available; if at least one further choice element is available, providing a sub-menu item that presents each available choice element; and if at least one further choice element is not available, automatically executing an action item related to the selected menu item. A selection of the menu item, sub-menu item or action execution can take place concurrently with the presentation of the broadcast content program.

The aspects of the disclosed embodiments allow for recognizing and accessing an interactive service even while a program is ongoing. As noted above, with respect to the example of FIG. 4B5, the new interactive services notification B502 can be provided to a user during the ongoing program. While a context menu has been described herein, with reference to FIG. 4B1, where the user can access the interactive services, in one embodiment, the user can access the available interactive services directly from the interactive services notification B502. For example, referring to FIG. 4F, screen F200 illustrates a program F202 that is running on the device. When a new interactive service is activated by the service provider, a notification F204 can be provided on the display, as shown in screen F210 of FIG. 4F. The new interactive service notification F204 can comprise a combination of textual indicators as well as graphical indicators. In alternate embodiments, the notification F204 can take on any suitable form that will identify that a new interactive service is available. As shown in FIG. 4F, the notification F204 can be provided or displayed on top of the live program picture F202.

In one embodiment, by selecting or contacting the new interactive service notification F204, the user can access further information and details regarding the interactive services that correspond to the new interactive service notification F204. For example, in one embodiment, where the device is a touch screen device, “touching” the new interactive services notification F204, will generate a list or menu F208 of the available interactive services as shown in screen F230. This menu F208 can include similar features as those described with respect to the menu B102 in FIG. 4B1. In one embodiment, touching the new interactive service notification F204 will first generate an “activating” indicator F206 that provides feedback to, or informs the user, that the list or menu F208 is being accessed and/or generated.

The menu F208 displays each of the available interactive services similar to the menu B102 described with respect to FIG. 4B1. From the menu F208, the desired interactive service can be activated. In this example, the user has the option to “vote” for an actor related to the program F202 or to visit a website. In one embodiment, selecting the “vote” for actor service indicator generates an SMS that sends the desired vote to a designated entity. Selecting the “visit” website service indicator will launch a suitable Internet browser and take the user from the program F202 to the indicated website. In the embodiment shown in this example, the new interactive service indicator F204 and interactive services menu F208 are displayed on top of the live picture F202 so that the user does not miss any part of the ongoing program F202. Thus, the user does not need to go to and open a separate options menu to determine if any interactive services are available, and then to access the available interactive services. Rather, the user is immediately notified that interactive services are available and by selecting the notification F204. The user is taken to the corresponding interactive services menu F208 while continuing to view the content of the program F202.

In one embodiment, determining if interactive services are available can include detecting a new interactive services notification on a display of the device while the broadcast content program is being presented; selecting the new interactive services notification to access a menu of available interactive services; and selecting a new interactive service element from the menu of available interactive service to access a sub-menu element related to the selected new interactive service element or execute an action related to the selected new interactive service. The menu can be displayed over the broadcast content program that is running on the device.

Most TV programs or broadcast contents are associated with an electronic programming guide. On example of an electronic programming guide is illustrated in FIG. 4D1. As shown in FIG. 4D1, the electronic programming guide D102 includes descriptors D104 that identify each of the channels or stations. The example shown in FIG. 4D1 has graphical images or icons identifying each channel. In alternate embodiments, any suitable indicator can be used to identify a particular channel.

A timeline D106, or other such suitable time indicator, divides the program times into time blocks or periods, moving from right-to-left along the program guide. Information related to a program that is being presented during a particular time period or slot is contained in the corresponding programming information block, such as block D108. For example, for the channel “BBC World”, the program “Sponge Bob™” is indicated as being programmed to be shown during the time period of “17:30-1800.” In alternate embodiments, any suitable format by which to present programming and channel information can be used and applied.

In some cases, all of the programming information related to a particular channel or program may not be fully visible. For example, in FIG. 4D1, a portion of the title and time in block D108 is cut off. This can occur for a number of reasons, including limitations on the viewable area of the display or because a program time period is short and all of the information cannot fit in the time block, such as shown in block B108. For example, referring to FIG. 4D3, programming guide D302 is shown. For the channel “BBC World” D304, the time block D306 is a half-hour time period. Due to the limited size of this half-hour time block D306, the full text of the program title for the scheduled program “Premier League Goal”, cannot be accommodated. Thus, only the partial title “Goal” is presented in conjunction in the time block D306. However, the aspects of the disclosed embodiments provide an extension information notification, such as the program indicator D404 shown in FIG. 4D4. The program indicator D404 can be used to provide full details related to a desired program, even when the corresponding time block is too small.

Referring to FIG. 4D2, the electronic program guide D202 is opened. As shown in FIG. 4D3, the program time block D306 is selected or “focused” on. A “focus” can occur when a cursor is positioned in the desired area. Alternately, in one embodiment, a first tap on the desired area will per-select or focus on the area. A second or subsequent tap might be used to select the area.

When the area D306 is focused on, the program indicator or notification D404, as shown in the electronic program guide D402 of FIG. 4D4, is presented and displays all of the program-related information, such as the full title and the time period for the program of the time block D306. In alternate embodiments, the program indicator D404 can include any suitable information related to the corresponding program. In one embodiment, the program indicator D404 can include graphical indicators or icons in addition to the textual information. When the focus is removed from the channel indicator D304, the program indicator D404 can be removed or “disappear” from view. In an alternate embodiment, the program indicator D404 can timeout. In one embodiment, the program indicator D404 can comprise a pop-up window or block.

In one embodiment, referring to FIG. 4D5, the program indicator D508 can include graphical indicators or icons that correspond to program reminders and program recording reminders. For example, the program indicator D508, which in one embodiment comprises a pop-up notification, includes a graphical indicator D510 that corresponds to a program reminder. The graphical indicator D510 can be used to inform the user that a reminder has been set for the selected program D506 on channel D504. The graphical indicator D512 corresponds to a program record reminder, indicating that the selected program D506 has been set to be recorded.

In one embodiment, graphical indicators can also be provided in the program time blocks, such as block D514 of the electronic program guide D502. In program time block D514, a graphical indicator D516 is provided that indicates that a program reminder has been set for the corresponding program. In block D518, the graphical indicator D520 corresponds to a program record reminder for this program in this time block. The graphical indicators shown in FIG. 4D5 are merely exemplary, and in alternate embodiments, any suitable indicator can be used. In one embodiment, the selection of, or focus on, one of the graphical indicators D510, D512, D516 or D520 can cause further details related to the reminder or recording represented by the selected indicator to be presented. The pop-up window D508 can include any information that cannot fit into the normal program block. For example, focusing on the indicator D520 can cause a pop-up window D507 to appear that provides information related to the channel and program to be recorded, as well as the length or time of the program. These features can provide advantages such as providing more information about scheduled programs and enables richer interaction with the device on which the scheduled program is being presented. In one embodiment, the information contained in the program indicator D508 can be processed in a text-to-speech application and audibly presented to the user.

The ability to set a reminder or set a program recording state for a program can be essential features in mobile TV applications. In one embodiment, referring to FIG. 4D5, an electronic program guide can include a “Set Reminder” and “Record” toolbar D509 that can provide single click interaction to set a reminder or recording. For example, in one embodiment, if the user desires to set a reminder for a program, i.e. a reminder that a program is about to start, the user can easily mark the desired program accordingly. A program reminder, as that term is used herein, generally means a reminder the informs the user that a specific program is about to start on a specific channel at a specific time. The user can select the set reminder icon D511 in the toolbar D509. The user can then select the desired program with which to associate the reminder. In this example, the program in program block D514 is selected. The reminder icon D516 is then presented in the program block D514 to indicate that the reminder is set. Similarly, if the user desires to set a program to be recorded, the user selects the “record” indicator or icon D513 in the toolbar D509. The user then selects the desired program, in this example, the program in program block D518, and the program is automatically set to be recorded. In one embodiment, the record indicator D520 is shown in the program block D518 to indicate that the program is set to be recorded.

The aspects of the disclosed embodiments allow a user to access, review and manage all future program recording events. In one embodiment, after opening the electronic program guide, a program recording view can open that provides a list identifying all programs set to be recorded in the device. Any programs set to be recorded in the device can be managed from the program recording view. For example, referring to FIG. 4E, a “My Recordings” view E102 is provided that indentifies and provides detailed information on all programs that have been set to be recorded. The user can select, view and modify any one of the programs in the list E108 that have been set to be recorded. For example, the show E104 on the “BBC World” channel has been set to be recorded on 23 May 2008, during the time period of 17:00-18:00. Relevant information related to the programmed recording can be displayed as well. A toolbar E106 provides access to functions and features that allow for managing and modifying the programs set to be recorded. The user can easily select the My Recordings view E102 on a mobile TV application device. In one embodiment, a designated key of the device can be programmed to automatically launch this view when the key is activated. This provides the advantage of improving the usability of the mobile TV application by making the application more understandable and flexible.

The aspects of the disclosed embodiments allow a user to automatically switch from the electronic program guide directly to a selected program by selecting a channel identifier for the desired channel in the electronic program guide. Referring to FIGS. 4I1-4I6, one example of a process to select a channel identifier to access a broadcast program channel is illustrated. FIG. 4I1 illustrates an example of a program I102 being presented on a display of a device. When the device is a touch screen device, in one embodiment, the user can contact the display of the device to activate or bring up a control and toolbar menu as shown in FIG. 4I2. As shown in FIG. 4I2, the control and toolbar menu can include tool selection buttons I104, volume control I106 and a program content indicator I108, for example. In alternate embodiments, the control menu can include any suitable controls that will allow a user to access an electronic program guide.

In this example, the program guide control I110 in FIG. 4I2 is selected which generates the electronic program guide I112 shown in FIG. 4I3. Once the electronic program guide I112 is activated, the user can see all ongoing and future programs for the available channels, as previously described herein. As shown in FIG. 4I3, the electronic program guide I112 includes channel identifiers or icons I114 associated with each of the program channels. If the user desires to switch to the program currently active on a channel, the user can select the icon corresponding to the desired channel, such as icon I116 as shown in FIG. 4I4. After selecting the icon I116, the electronic program guide I112 automatically closes and the program channel corresponding to the selected icon I116 is loaded. In one embodiment, a channel loading indicator I118 can be presented over the currently running program I102, as shown in FIG. 4I5. After the selected channel is loaded, the corresponding program I120 is presented, as shown in FIG. 4I6. Thus, the aspects of the disclosed embodiments provide for the fast selection of, and switching to, a current program by simply selecting a channel icon or logo, or other identifier, from an electronic program guide.

The aspects of the disclosed embodiments also allow for changing a channel of the broadcast content device to be carried out in a simplified manner. In one embodiment, referring to FIG. 4A, changing the channel of the broadcast content device can be carried out with a sweep gesture of a touch screen pointer across the screen of the mobile TV device. When the picture on a mobile TV device is in a full screen mode, it can be difficult to perceive how to change the channel that is currently being viewed. In many devices, a channel changing function is not displayed when the display is in a full screen mode. With certain devices, the availability of hardware keys to enable a channel change may not be present. The aspects of the disclosed embodiments provide for using a sweeping style gesture or movement to change the channel on the mobile TV device.

For example, referring to FIG. 4A, as shown in screen A10, a touch screen pointer A104 is used to contact the display and is moved in an orthogonal direction relative to the display to change the channel, going from screen A10 to screen A16. In one embodiment, the touch screen pointer A104 can comprise the user's finger. The change in channel can be dependent upon the direction of the movement or gesture. In this example, a left-to-right movement will cause the device to advance the channel to a higher channel. A right-to-left movement, as shown by A106 in FIG. 4A, can cause the channel to change to a prior or lower channel. In alternate embodiments, any suitable movement, or direction of movement can be used to change the channel. For example, a left-to-right movement can cause the channel to change to a lower channel, while a right-to-left movement can cause the channel to change to a higher channel. A bottom-to-top movement can cause a change to a higher channel, while a top-to-bottom movement can cause a change to a lower channel, or vice versa.

In one embodiment, the movement does not have to be across the entire display area to cause a channel change, but rather the movement can be limited to being across or along a portion of the display area to cause a corresponding channel change. For example, a movement that goes one-quarter or halfway across the display area can cause a channel change. The change in channel can be one channel, or more than one channel, depending on the extent of the movement. For example, in one embodiment, a one-half movement may correspond to a one-channel change, while a movement across the entire display may correspond to a two or more channel change. In alternate embodiments, any suitable movement can be associated with a corresponding channel change.

In the example shown in FIG. 4A, the contact of the pointing device A104 is shown to be at a location that is slightly to the right of the midpoint of the display. The movement A106 of the pointer A104 extends only along a portion of the display area to effectuate a channel change, as shown in screen A10.

Although the movement A106 on the screen A10 can cause an immediate change of channel, in one embodiment, a channel loading dialog A110 shown in screen A108 of FIG. A1 can be used to provide feedback about the channel change. As shown in FIG. 4A, the channel loading dialog A110 is presented on the screen and describes the gesture. The channel loading dialog A110 can provide information related to the channel, and can include the station identifier, the name of the current program and the program time duration, for example. In one embodiment, the channel loading dialog identifies the channel change after detecting the movement. In alternate embodiments, any suitable program and station or channel information can be provided in the channel loading dialog A110. In one embodiment, the channel loading dialog can be animated and move in a direction corresponding to the direction of the gesture. For example, an animated channel loading dialog can move across the display in a direction corresponding to the detected movement. As shown in screen A108, the channel loading dialog box A110 appears to move from right-to-left, corresponding to the direction of movement A106 of the touch screen pointer A104 in screen A10 going from screen A12 to screen A14. The channel can then change, as shown in screen A16. Although the channel loading dialog A110 is shown as appearing in conjunction with the program being viewed prior to the channel change, in one embodiment the channel loading dialog A110 can be presented in conjunction with the new channel. Thus, the aspects of the disclosed embodiments provide that while the mobile TV device is in a full screen mode, the channel can be changed by a sweeping style gesture or movement, without any need for additional hard or soft keys.

The aspects of the disclosed embodiments allow a user to preview the content of a desired channel prior to selecting or switching to the channel. For example, referring to FIG. 4G, a program channel selection screen G100 is shown. A list G102 of available channels and the corresponding programs is presented in one area of the screen. A channel preview region G106 is presented in an adjacent area of the screen. A live feed of the content or program of a channel from the list of available channels can be presented in the preview region G106.

When a user focuses on, or highlights, a desired channel, such as channel G104 shown in FIG. 4G, a live feed of that channel is presented in the preview region G106. This allows the user to preview a content of a desired channel prior to switching to or selecting the channel. In one embodiment, to switch to or select a desired channel, the user can activate the highlighted channel G104 or select the preview region G106 where the live feed of the channel is being presented. A full screen view of the selected or activated channel can then be provided. For example, the user can “tap” the highlighted channel G104 or the preview region G106 one or more time to select and/or switch to a normal or full screen view of the channel being previewed. This allows the user to access more information regarding a broadcasted program prior to making a decision whether to switch to the channel presenting the broadcasted program. The usability and effectiveness of the device and application is improved.

In terminal style TV application devices, a keypad lock function is used to disable the device and prevent the inadvertent activation of the device due to an errant or accidental key press. The activation of a keypad lock function generally disables the keypad, display lighting as well as streaming media functionality. Thus, when a keypad lock or key lock function is activated on a terminal that is capable of presenting broadcast content, such as TV and video, the display illumination and media streaming capabilities are typically disabled and the user is no longer able to watch a TV broadcast. In accordance with the aspects of the disclosed embodiments, when the keypad lock function of the terminal is activated, the illumination of the display of the terminal is not disabled, and the streaming functionality remains active. Thus, the user is able to continue to watch broadcast content, such as a TV broadcast, even when the keypad lock function is active.

For example, referring to FIG. 4C, in one embodiment, the activation of a keypad lock function is detected C102. It is determined C104 whether a broadcast content program, such as a TV broadcast, is currently active or running. If a broadcast content program is not running, the standard keypad lock functions are enabled, such as for example, disabling the keypad, preventing illumination of the display, and disabling media streaming functionality.

If it is determined that a broadcast content program is active or running, certain features of the standard keypad lock functionality are not enabled. In one embodiment, the display functionality C108 and the media streaming functionality C110 are maintained while keypad lock function is active and other keypad lock functions are enabled. In alternate embodiments, any suitable functionality can be enabled while the keypad lock function is active in order to allow broadcast content to be presented and viewed.

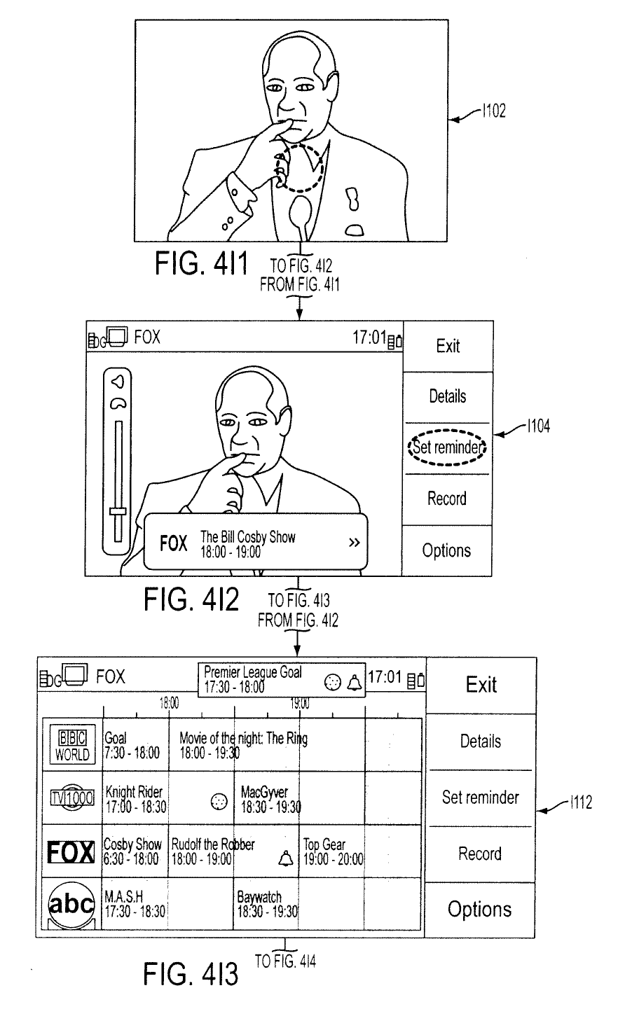

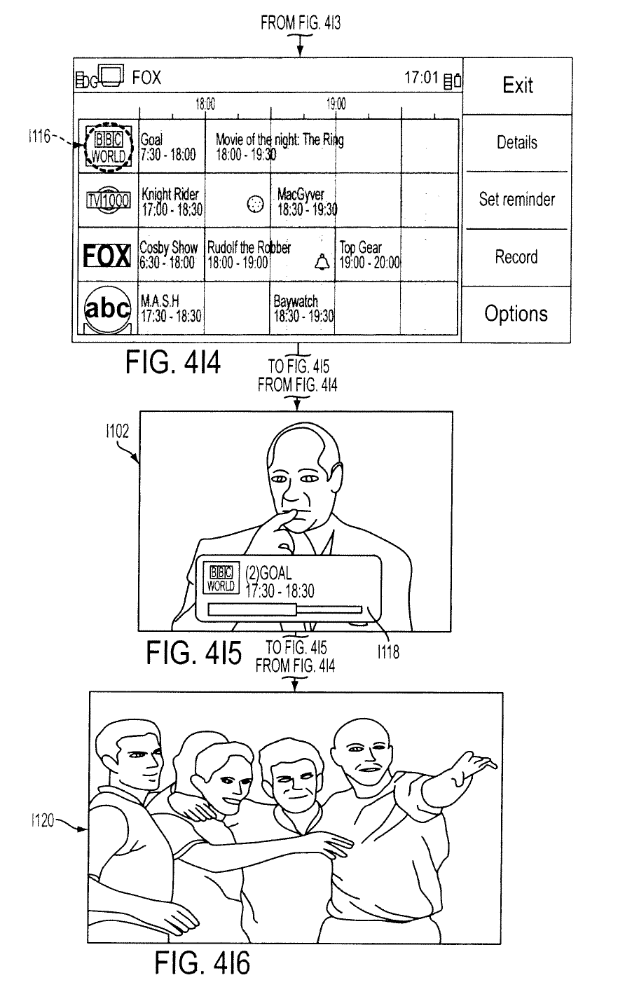

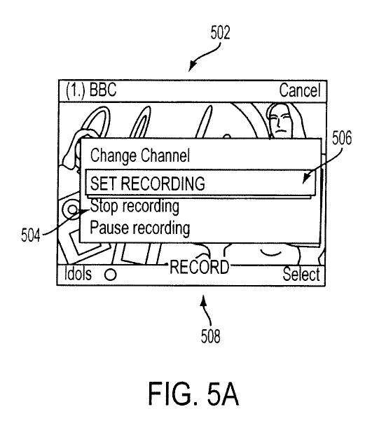

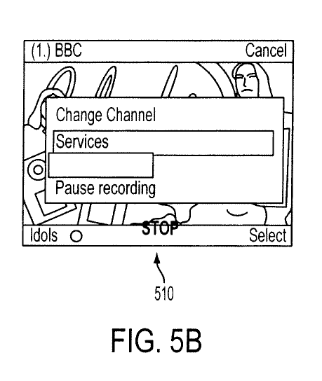

The user interface of the disclosed embodiments can have several states that change without the need for any user interaction. Referring to FIGS. 5A and 5B, one example of state changes without user interaction is shown. These states can include changing the functionality of the soft keys of the device to correspond to the particular state of an application(s) that is active on the device. In one embodiment, where a broadcast content application 502 such as a mobile TV application is active, the middle soft key functionality of the device will change to correspond to the particular state of the application. In one embodiment, the device interprets the current state of the application and changes the functionality of, and the corresponding label of, the middle soft key device. For example, a function that corresponds to a particular state of a mobile TV application can be assigned to the middle soft key. The label of the middle soft key will change to inform the user of the corresponding functionality and/or state. In this example, a recording menu 504 is displayed in conjunction with the broadcast content application 502. When the recording menu 504 is called up or activated, the function of the middle soft key changes to the “Record” function 508. In this state of the user interface, activating the middle soft key will start the record function. If the record function 508 is activated by selecting the middle soft key, the state of the user interface can automatically change to that displayed in FIG. 5B. In this embodiment, the middle soft key functionality has changed to the “Stop” function 510. Activating the middle soft key when the Stop function 510 is displayed, will cause the recording to stop. Although this embodiment is described in terms of the middle soft key of the device, it will be understood that any suitable soft key of the device can be used.

The aspects of the disclosed embodiments provide a simplified mechanism to purchase content access rights in mobile TV applications. In one embodiment, referring to FIG. 4H, when a user selects a channel for which access rights must be purchased, a screen H100 is presented that informs the user that the content must be purchased prior to accessing the channel and viewing the contact. For example, the screen H100 provides a text style message or pop-up H102 that the user does not have usage rights for the selected channel. In one embodiment, a function key or selection button H104 can be provided on the screen H100 that will allow the user to easily and quickly start the purchasing process by selecting the button. Selection of the button H104 can immediately take the user to a purchasing options screen. The user does not have to separately access an options menu to purchase the access rights to the channel. Thus, the use of the function button H104 improves the usability of the purchasing process in a mobile TV application by providing an easy and understandable mechanism and interface to purchase channel and content access rights.

In one embodiment, a channel is selected in a broadcast content application device; a payment request to obtain access to the selected channel is detected; and the purchase selection button on a user interface corresponding to the selected channel is activated to initiate the purchase process to access content provided on the selected channel.

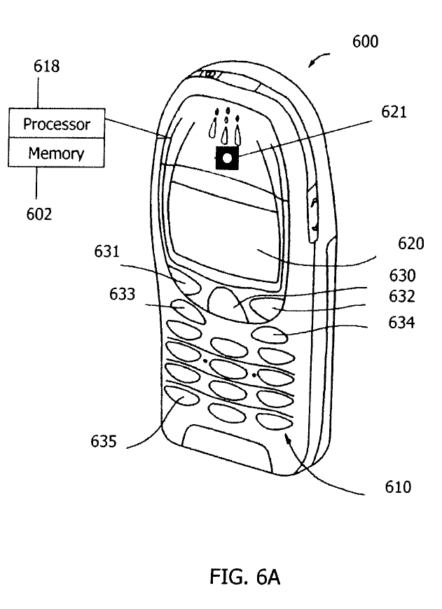

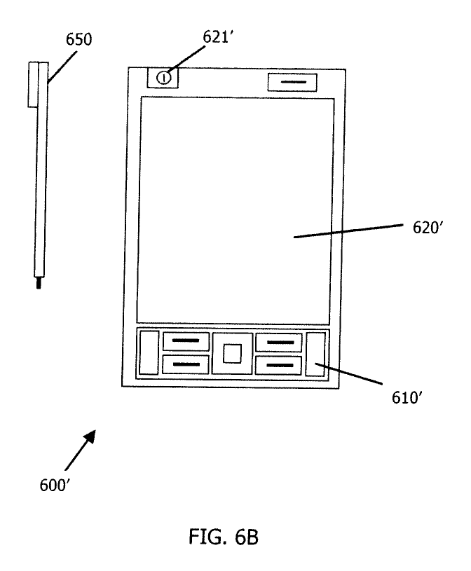

Some additional examples of devices on which aspects of the disclosed embodiments can be practiced are illustrated with respect to FIGS. 6A-6B. The devices are merely exemplary and are not intended to encompass all possible devices or all aspects of devices on which the disclosed embodiments can be practiced. The aspects of the disclosed embodiments can rely on very basic capabilities of devices and their user interface. Buttons or key inputs can be used for selecting and controlling the functions and commands described herein, and a scroll key function can be used to move to and select item(s), such as text.

As shown in FIG. 6A, in one embodiment, the device 600, which in one embodiment comprises a mobile communication device or terminal may have a keypad 610 as an input device and a display 620 for an output device. In one embodiment, the keypad 610 forms part of the display unit 620. The keypad 610 may include any suitable user input devices such as, for example, a multi-function/scroll key 630, soft keys 631, 632, a call key 633, an end call key 634 and alphanumeric keys 635. In one embodiment, the device 600 includes an image capture device such as a camera 621, as a further input device. The display 620 may be any suitable display, such as for example, a touch screen display or graphical user interface. The display may be integral to the device 600 or the display may be a peripheral display connected or coupled to the device 600. A pointing device, such as for example, a stylus, pen or simply the user's finger may be used in conjunction with the display 620 for cursor movement, menu selection, text selection and other input and commands. In alternate embodiments, any suitable pointing or touch device may be used. In other alternate embodiments, the display may be a conventional display. The device 600 may also include other suitable features such as, for example a loud speaker, headset, tactile feedback devices or connectivity port. The mobile communications device may have at least one processor 618 connected or coupled to the display for processing user inputs and displaying information and links on the display 620, as well as carrying out the method steps described herein. At least one memory device 602 may be connected or coupled to the processor 618 for storing any suitable information, data, settings and/or applications associated with the mobile communications device 600.

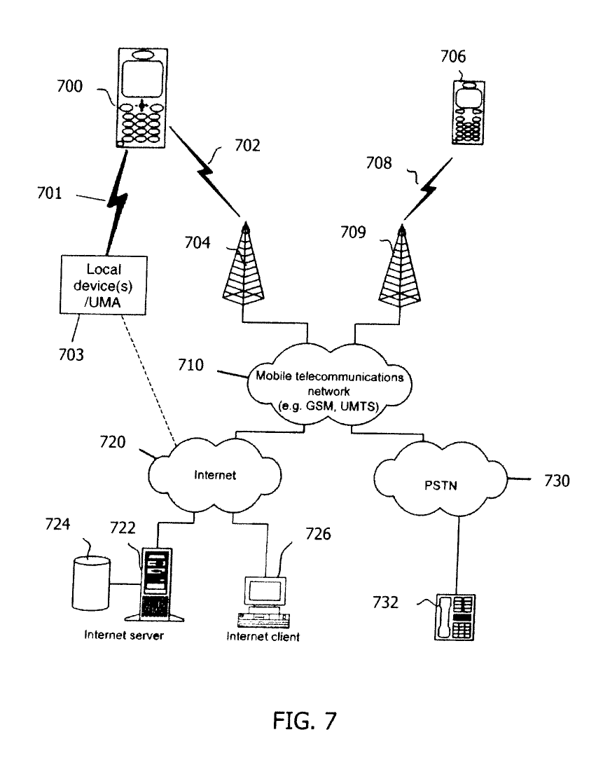

In the embodiment where the device 600 comprises a mobile communications device, the device can be adapted for communication in a telecommunication system, such as that shown in FIG. 7. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 700 and other devices, such as another mobile terminal 706, a line telephone 732, a computing device 726 and/or an internet server 722.

In one embodiment the system is configured to enable any one or combination of chat messaging, instant messaging, text messaging and/or electronic mail, and the text-to-speech conversion process described herein can be applied to the computer understandable text in such messages and/or communications. It is to be noted that for different embodiments of the mobile device or terminal 700, and in different situations, some of the telecommunications services indicated above may or may not be available. The aspects of the disclosed embodiments are not limited to any particular set of services or communication system, protocol or language in this respect.

The mobile terminals 700, 706 may be connected to a mobile telecommunications network 710 through radio frequency (RF) links 702, 708 via base stations 704, 709. The mobile telecommunications network 710 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), WLAN, freedom of mobile multimedia access (FOMA) and time division-synchronous code division multiple access (TD-SCDMA).

The mobile telecommunications network 710 may be operatively connected to a wide area network 720, which may be the Internet or a part thereof. An Internet server 722 has data storage 724 and is connected to the wide area network 720, as is an Internet client 726. The server 722 may host a worldwide web/wireless application protocol server capable of serving worldwide web/wireless application protocol content to the mobile terminal 700.

A public switched telephone network (PSTN) 730 may be connected to the mobile telecommunications network 710 in a familiar manner. Various telephone terminals, including the stationary telephone 732, may be connected to the public switched telephone network 730.

The mobile terminal 700 is also capable of communicating locally via a local link 701 to one or more local devices 703. The local links 701 may be any suitable type of link or piconet with a limited range, such as for example Bluetooth™, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values or other signals to the mobile terminal 700 over the local link 701. The above examples are not intended to be limiting, and any suitable type of link or short range communication protocol may be utilized. The local devices 703 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 700 may thus have multi-radio capability for connecting wirelessly using mobile communications network 710, wireless local area network or both. Communication with the mobile telecommunications network 710 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the process module 122 of FIG. 1 includes communications module 134 that is configured to interact with, and communicate to/from, the system described with respect to FIG. 7.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the system 100 of FIG. 1 may be for example, a personal digital assistant (PDA) style device 600′ illustrated in FIG. 6B. The personal digital assistant 600′ may have a keypad 610′, a touch screen display 620′, camera 621′ and a pointing device 650 for use on the touch screen display 620′. In still other alternate embodiments, the device may be a personal computer, a tablet computer, touch pad device, Internet tablet, a laptop or desktop computer, a mobile terminal, a cellular/mobile phone, a multimedia device, a personal communicator, a television or television set top box, a digital video/versatile disk (DVD) or High Definition player or any other suitable device capable of containing for example a display 114 shown in FIG. 1, and supported electronics such as the processor 618 and memory 602 of FIG. 6A. In one embodiment, these devices will be Internet enabled and can include map and global positioning system (“GPS”) capability.

The user interface 102 of FIG. 1 can also include menu systems 124 coupled to the processing module 122 for allowing user input and commands. The processing module 122 provides for the control of certain processes of the system 100 including, but not limited to, the controls for selecting files and objects, establishing and selecting search and relationship criteria, navigating among the search results, identifying interactive services in broadcast contents and programs and detecting control movement for interacting with the interactive services. The menu system 124 can provide for the selection of different tools and application options related to the applications or programs running on the system 100 in accordance with the disclosed embodiments. In the embodiments disclosed herein, the process module 122 receives certain inputs, such as for example, signals, transmissions, instructions or commands related to the functions of the system 100, such as messages, notifications, start and stop points and state change requests. Depending on the inputs, the process module 122 interprets the commands and directs the applications process control 132 to execute the commands accordingly in conjunction with the other modules.

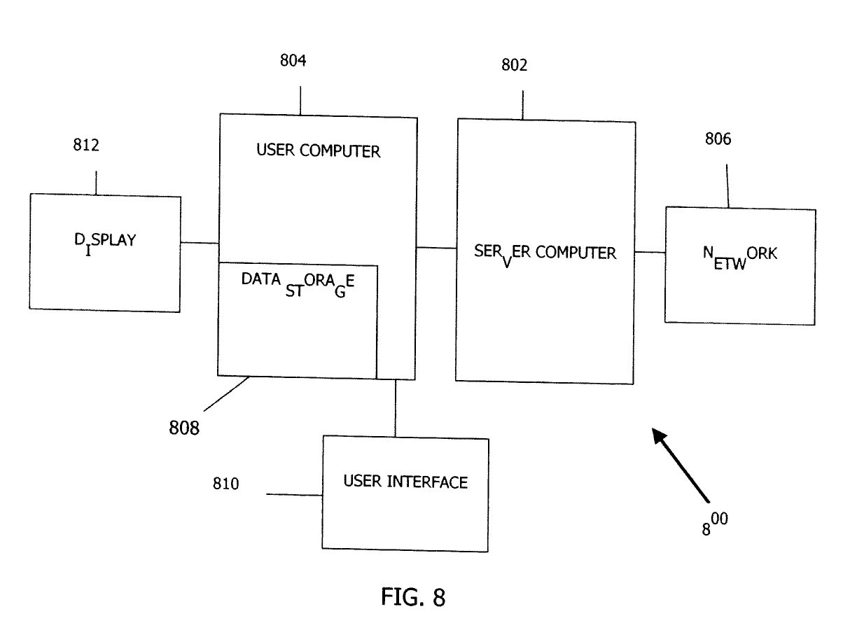

The disclosed embodiments may also include software and computer programs incorporating the process steps and instructions described above. In one embodiment, the programs incorporating the process steps described herein can be executed in one or more computers. FIG. 8 is a block diagram of one embodiment of a typical apparatus 800 incorporating features that may be used to practice aspects of the invention. The apparatus 800 can include computer readable program code means for carrying out and executing the process steps described herein. In one embodiment the computer readable program code is stored in a memory of the device. In alternate embodiments the computer readable program code can be stored in memory or memory medium that is external to, or remote from, the apparatus 800. The memory can be direct coupled or wireless coupled to the apparatus 800. As shown, a computer system 802 may be linked to another computer system 804, such that the computers 802 and 804 are capable of sending information to each other and receiving information from each other. In one embodiment, computer system 802 could include a server computer adapted to communicate with a network 806. Alternatively, where only one computer system is used, such as computer 804, computer 804 will be configured to communicate with and interact with the network 806. Computer systems 802 and 804 can be linked together in any conventional manner including, for example, a modem, wireless, hard wire connection, or fiber optic link. Generally, information can be made available to both computer systems 802 and 804 using a communication protocol typically sent over a communication channel or other suitable connection or line, communication channel or link. In one embodiment, the communication channel comprises a suitable broad-band communication channel. Computers 802 and 804 are generally adapted to utilize program storage devices embodying machine-readable program source code, which is adapted to cause the computers 802 and 804 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the disclosed embodiments may be stored in one or more computers 802 and 804 on an otherwise conventional program storage device. In one embodiment, computers 802 and 804 may include a user interface 810, and/or a display interface 812 from which aspects of the invention can be accessed. The user interface 810 and the display interface 812, which in one embodiment can comprise a single interface, can be adapted to allow the input of queries and commands to the system, as well as present the results of the commands and queries, as described with reference to FIG. 1, for example.

It is noted that the embodiments described herein can be used individually or in any combination thereof. It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. A method comprising:
providing an electronic program guide that presents content programming information for one or more program channels on a broadcast TV device;
detecting a selection of a program block in the electronic program guide, the selected program block corresponding to a program scheduled on a program channel;
providing a program indicator block corresponding to the selected program block, the program indicator presenting detailed programming information related to the scheduled program including any program reminder or program recording state setting;
detecting a selection of a channel identifier in the electronic program guide corresponding to a program channel;
automatically switching to a broadcast content program corresponding to the selected channel identifier after detecting the selection of the channel identifier; and
automatically closing the electronic program guide.

2. The method of claim 1 further comprising:
after providing the electronic program guide, detecting a selection of an indicator from an indicator toolbar presented on the electronic program guide for setting a program reminder or a program recording state;
selecting a program block for a program channel to be associated with the selected indicator;
automatically setting the program reminder or program recording state for the selected program block; and
presenting a graphical indicator in the selected program block that corresponds to the selected indicator.

3. A method comprising:
detecting a selection of a channel identifier in an electronic program guide corresponding to a content channel;
automatically switching to a broadcast content program corresponding to the selected channel identifier; and
automatically closing the electronic program guide.

4. The method of claim 3, further comprising, prior to selecting the channel identifier:
activating a controls menu of a mobile TV application in a touch screen device by contacting a screen of the touch screen device while a broadcast content program is running; and
selecting a program guide control to open the electronic program guide.

5. A method comprising:
detecting contact of a touch screen pointing device with a display of a broadcast content device while the broadcast content device is in a full screen mode;
detecting movement of the touch screen pointing device in a substantially orthogonal direction relative to an edge of the display; and
changing a channel of the broadcast content device depending upon a direction of the detected movement.

6. The method of claim 5 further comprising advancing the channel to at least one next channel when the detected movement is one of a right-to left, left-to-right, top-to-bottom or bottom-to-top movement relative to the edge of the display.

7. The method of claim 5 further comprising changing the channel to at least one prior channel when the detected movement is one of a right-to-left, left-to-right, top-to-bottom or bottom-to-top movement relative to the edge of the display.

8. A method comprising:
detecting a selection of a channel preview application in a broadcast content device;
displaying a list of available channels on a display of the broadcast content device;
providing a preview area adjacent to the list of available channels on the broadcast content device;
highlighting one of the channels from the list of available channels, wherein a live feed of a content of the highlighted channel is presented in the preview area;
detecting a selection of the highlighted channel; and
providing a full screen view of the selected channel.

9. The method of claim 8 wherein selecting the highlighted channel further comprises activating the highlighted channel from the list of available channels or selecting the preview area.

10. The method of claim 8 further comprising highlighting another one of the channels from the list of available channels to view a live feed of a content of the another channel in the preview area.

11. A method comprising:
detecting an activation of a keypad lock function of a device on which a broadcast content program is being presented; and
enabling an illumination function of a display of the device and a video streaming function to enable the continued presentation of the broadcast content program while the keypad lock function is enabled.

12. The method of claim 11 further comprising enabling selection of at least one menu item from a context menu presenting selectable menu items when the keypad lock function is active.

13. An apparatus comprising:
a command input device;
a display device configured to display broadcast content and content information; and
at least one processor communicating with the display device, the at least one processor being configured to:
provide an electronic program guide to the display device, the electronic program guide corresponding to the broadcast content;
detect a selection of a program block in the electronic program guide by the command input device, the selected program block corresponding to a scheduled program on a content channel; and
provide a program indicator block that provides detailed programming information related to the selected program block including any program reminder or program recording information.

14. The apparatus of claim 13 wherein the broadcast content is television broadcast content.

15. The apparatus of claim 13 further comprising that the apparatus is a mobile communication device.

16. The apparatus of claim 13 further comprising that the at least one processor is configured to:
detect a selection by the command input device of an indicator on the electronic program guide, the indicator corresponding to a set program reminder or set program recording state;
detect a selection by the command input device of a program block for a program channel to be associated with the selected indicator; and
automatically setting a program reminder or program recording state for the selected program block.

17. The apparatus of claim 13 further comprising that the at least one processor is configured to:
detect a selection of a channel identifier in the electronic program guide corresponding to a content channel; and
automatically switch to a broadcast content program corresponding to the selected channel identifier.

18. The apparatus of claim 17 further comprising that the at least one processor is configured to:
detect selection of a control menu of a mobile TV application while a broadcast content program is running on a touch screen device, the selection comprising contact a display of the touch screen device; and
automatically open the electronic program guide.

19. The apparatus of claim 14 wherein the at least one processor is further configured to, while the broadcast content is displayed:
detect contact of a touch screen pointing device with the display device;
detect movement of the touch screen pointing device on the display device that is in a substantially orthogonal direction relative to an edge of the display device; and
change a content channel depending upon a direction of the detected movement.

20. The apparatus of claim 19 wherein the at least one processor is configured to change the channel to a higher or lower channel when the detected movement is one of a right-to-left, left-to-right, top-to-bottom or bottom-to-top movement relative to the edge of the display device.

21. The apparatus of claim 13 further comprising, that the at least one processor is configured to, while the broadcast content is displayed:
detect a selection of a channel preview application;
display a list of available channels on the display device;
provide a preview area adjacent to the list of available channels on the display device;
highlight one of the channels from the list of available channels, wherein a live feed of a content of the highlighted channel is presented in the preview area; and
detect a selection of the highlighted channel; and
provide a full screen view of the selected channel.

22. The apparatus of claim 21, wherein the at least one processor is further configured to detect a selection of the highlighted channel by detecting an activation of the highlighted channel from the list of available channels or detecting a selection of the preview are in which the highlighted channel is being presented.

23. The apparatus of claim 13 wherein the at least one processor is further configured to:
detect an activation of a keypad lock function of the apparatus while broadcast content is being presented on the display device;
enable the display device to continue to present the broadcast content while the keypad lock function is enabled.

24. The apparatus of claim 23 wherein the at least one processor is configured to enable the display device to continue to present the broadcast content while the keypad lock function is enabled by enabling a display illumination function of the display device and a video streaming function while the keypad lock function is active.

25. A computer program product stored in a memory comprising computer program code means configured to carry out the method according to claim 1.

26. A computer program product stored in a memory comprising computer program code means configured to carry out the method according to claim 3.

27. A computer program product stored in a memory comprising computer program code means configured to carry out the method according to claim 5.

28. A computer program product stored in a memory comprising computer program code means configured to carry out the method according to claim 8.

29. A computer program product stored in a memory comprising computer program code means configured to carry out the method according to claim 11.
